(19) United States
(12) Patent Application Publication
(10) Pub. No.: US 2022/0371871 A1
(43) Pub. Date: Nov. 24, 2022

(54) Implement for Opening Sealed Beverage Lever Tab Cans, Twist Cap Bottles and Pop-Off Cap Bottles

(71) Applicant: Bite Coolers, LLC, Fort Wayne, IN (US)

(72) Inventor: Brett Warren Thomas, Fort Wayne, IN (US)

(73) Assignee: Bite Coolers, LLC, Fort Wayne, IN (US)

(21) Appl. No.: 17/743,010

(22) Filed: May 12, 2022

Related U.S. Application Data
(60) Provisional application No. 63/191,127, filed on May 20, 2021.

(51) Int. Cl. B67B 7/44; B67B 7/40; B67B 7/16; B65D 81/38

(52) U.S. Cl. CPC B67B 7/44; B67B 7/403; B67B 7/16; B65D 81/3879

(57) ABSTRACT

An implement for opening a variety of sealed beverage containers including those having pop-off caps, twist off caps, and lever tabs. The implement comprises a pop-off cap opening tool that is engageable with a pop-off cap, a twist off cap opening tool that is engageable with a twist off cap, and a lever tab opening tool that is engageable with a lever tab. The pop-off cap opening tool is stacked on top of the twist off cap opening tool and a passage opening extends through the twist off cap opening tool wherethrough the pop-off cap opening tool is accessible. To engage a pop-off cap with the pop-off cap opening tool, the pop-off cap is inserted through the passage opening. The implement can be secured to an insulated sleeve adapted to receive beverages and/or beverage containers.

### CROSS REFERENCE TO RELATED APPLICATIONS

This application claims priority under 35 U.S.C. 119(e) of U.S. provisional patent application Ser. No. 63/191,127 filed on May 20, 2021, entitled Implement for Opening Sealed Beverage Lever Tab Cans, Twist Cap Bottles and Pop-Off Cap Bottles, the disclosure of which is hereby incorporated herein by reference.

### BACKGROUND OF THE INVENTION

### 1. Field of the Invention

The present invention relates to the field of devices used to open sealed beverage containers, namely: beverage cans openable by tipping up a lever tab to punch open a pre-scored flap opening (“lever tab cans”); beverage bottles openable by twisting off the crown cap thereof (“twist cap bottles”); and, beverage bottles openable by popping off the crown cap thereof using a lever opener to push up the pleated cap edge to bend and remove the cap (“pop-off cap bottles”). More particularly, the present invention is directed to an implement for opening sealed beverage lever tab cans, twist cap bottles and pop-off cap bottles. The implement can be integrated and combined with other devices and apparatus such as insulating sleeves which are sometimes referred to as “coolers” and which are adapted to receive and insulate beverages and/or beverage containers.

### 2. Background

Sealed beverage containers including lever tab cans, twist cap bottles, and pop-off cap bottles are commonly used for a wide variety of beverages. Accordingly, it is well known to provide individual tools useful for opening one type of container and additional tools to open the other types of containers. Additionally, there are known implements which combine tools useful for opening sealed beverage lever tab cans, twist cap bottles and pop-off cap bottles into one device. Examples of prior implements combining two or more tools are shown and described in Bailey, U.S. Pat. No. 9,120,659; Kehoe, U.S. Pat. No. 7,240,589; Phillips, U.S. Pat. No. 4,967,622; Widman, U.S. Pat. No. 4,549,451; Bryant et al., U.S. Pat. No. 4,846,024; and Turner, U.S. Pub. 2005/0252343.

It is also known that beverage containers can incorporate one or more tools for opening sealed beverage containers including tools for opening lever tab cans, twist cap bottles, and pop-off cap bottles. Examples of beverage containers incorporating tools for opening sealed beverage containers are shown and described in Howlett et al., U.S. Pat. No. 7,343,834; Grunwald, U.S. Pat. No. 2,745,301; Trafton, U.S. Pat. No. D721,924; Choate, U.S. Pub. 2008/0098853; and McGrath et al., U.S. Pub. 2006/0016294.

Insulated sleeves are known and commonly used to receive and insulate beverages and/or beverage containers. These insulated sleeves are often constructed with an inner cup for containing the beverage and/or beverage container, an outer cylinder secured to the inner cup for thereby forming a sleeve, and a bottom disc secured to the outer cylinder thereby hermetically sealing the sleeve, wherein the bottom disc has a valve for thereby allowing a vacuum to be formed within the sleeve and thereby insulating the inner cup.

Although there are currently known tools for opening lever tab cans, twist cap bottles and pop-off cap bottles, a need exists for an improved single implement capable of opening all three. A need also exists for an improved means of readily integrating and combining such an implement with other devices and apparatus such as insulating sleeves adapted to receive and insulate beverages and/or beverage containers.

### SUMMARY OF THE INVENTION

In one form thereof, the present invention is directed to an implement for opening a sealed beverage container. The implement includes a pop-off cap opening tool, a twist off cap opening tool secured to the pop-off cap opening tool, and a passage opening extending through the twist off cap opening tool wherethrough the pop-off cap opening tool is accessible. The pop-off cap opening tool is adapted to engage the pop-off cap of a pop-off cap bottle, and the twist off cap opening tool is adapted to engage the twist-off cap of a twist off cap bottle. To engage the pop-off cap opening tool with a pop-off cap, the pop-off cap is inserted through the passage opening.

The implement can include a lever tab opening tool that is engageable with the lever tab of a lever tab can. Preferably, the lever tab opening tool is a lever tab receiving slot extending into a side of the implement and adapted to receive a lever tab therein.

The pop-off cap opening tool can include a pop-off tool member having a first base section and a pop-off cap receiving opening provided through the first base section. The pop-off cap receiving opening has a fulcrum edge and a lift edge which is opposite the fulcrum edge. The fulcrum edge and the lift edge are configured to engage the pop-off cap.

Preferably, the twist off cap opening tool includes a twist off tool member having a second base section and a twist off cap receiving opening provided through the second base section. The twist off cap receiving opening has a plurality of sinusoidal ridges extending along a first edge thereof. The plurality of sinusoidal ridges are configured to engage a twist off cap.

Preferably, the first edge of the twist off cap opening extends along an arc length of less than 180°.

Preferably, the twist off cap receiving opening is sized to allow a pop-off cap to pass therethrough to engage the pop-off cap opening tool such that the twist off cap receiving opening functions as the passage opening.

Preferably, the first base section further comprises a bottom surface which is adjacent and facing the second base section. The twist off cap further includes a top surface, and, when the twist off cap engages the twist off cap receiving opening, the top surface of the twist off cap abuts the bottom surface of the first base section.

In another form thereof, the present invention is directed to an implement having a beverage sleeve, a twist off cap opening tool, and a pop-off cap opening tool located between the beverage sleeve and the twist off cap opening tool. A passage opening extends through the twist off cap opening tool wherethrough the pop-off cap opening tool is accessible. To engage the pop-off cap with the pop-off cap opening tool, the pop-off cap is inserted through the passage opening. The implement can include the further improvements and embodiments as described herein above with respect to the implement.

Preferably, the beverage sleeve has a beverage cavity. In one embodiment, the beverage cavity can be configured to receive a beverage therein. In another embodiment, the beverage cavity can be configured to receive a beverage container therein.

Preferably, the beverage sleeve is thermally insulated. In one embodiment, the beverage sleeve comprises a thermally insulating cup member. The thermally insulating cup member can include an outer cylindrical member having an inner cup receiving bore, an inner cup member having an upper annular edge, and a bottom disc member having a valve. The inner cup member is configured to be received within the inner cup receiving bore. The outer cylindrical member is joined to the inner cup member at the upper annular edge thereof, thereby forming a cavity between the outer cylindrical member and the inner cup member. The bottom disc member is joined to the outer cylindrical member opposite the upper annular edge for thereby hermetically sealing the cavity. Air can be drawn out of the cavity through the valve in the bottom disc for thereby forming a vacuum within the cavity and thermally insulating the inner cup member. In another embodiment, the thermally insulating cup member can be constructed from a low density thermally insulative solid.

### BRIEF DESCRIPTION OF THE DRAWINGS

The above mentioned and other features and objects of this invention, and the manner of attaining them, will become more apparent and the invention itself will be better understood by reference to the following description of the embodiments of the invention taken in conjunction with the accompanying drawings, wherein:

FIG. 1 is a perspective view of an implement constructed in accordance with the principles of the present invention for opening lever tab cans, twist cap bottles and pop-off cap bottles and which is integrated with an insulated sleeve, and showing a lever tab can beverage container received within the sleeve;

FIG. 2 is an exploded perspective view of the implement and insulated sleeve shown in FIG. 1;

FIG. 3 is another exploded view of the implement and insulated sleeve shown in FIG. 1 from another perspective;

FIG. 4 is yet another exploded view of the implement and insulated sleeve shown in FIG. 1 from yet a different perspective;

FIG. 5 is a perspective view of the bottom end of the implement and insulating sleeve shown in FIG. 1;

FIG. 6 is a plan view of the bottom end of the implement and insulating sleeve shown in FIG. 1;

FIG. 7 is a perspective view of the implement and insulating sleeve shown in FIG. 1 being used to tip up and pivot a can lever tab about its rivet for pushing/punching the pre-scored flap into the can;

FIG. 8 is a perspective view of the implement and insulating sleeve shown in FIG. 1 being used to turn counterclockwise and threadingly disengage a twist off crown cap from a glass bottle;

FIG. 9 is a perspective view similar to FIG. 8 but from another perspective;

FIG. 10 is a perspective view of the implement and insulating sleeve shown in FIG. 1 being used to pop off a pop-off crown cap from a glass bottle;

FIG. 11 is a perspective view similar to FIG. 10 but from another perspective;

FIG. 12 is a partial cross section view of the insulated sleeve and implement taken along line 12-12 of FIG. 1, and showing a pop-off cap bottle inserted and extending through the twist off crown cap receiving opening and with the pop-off crown cap extending partially through the pop-off crown cap tool opening just prior ro disengaging/removing the pop-off crown cap;

FIG. 13 is a cross section view similar to FIG. 12 but showing a lever tab of a beverage can inserted and extending into the implement lever tab receiving slot just prior to pivoting the insulated sleeve and the implement being tipped for thereby pivoting the lever tab about its rivet for pushing/punching the pre-scored flap into the can; and,

FIG. 14 is a cross section view similar to FIG. 12 but showing a twist off bottle cap inserted into the twist off crown cap receiving opening with the cap sinusoidal shaped pleated edge in engagement with the twist off cap tool member sinusoidal shaped edge just prior to twisting and disengaging/removing the twist off crown cap.

Corresponding reference characters indicate corresponding parts throughout several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

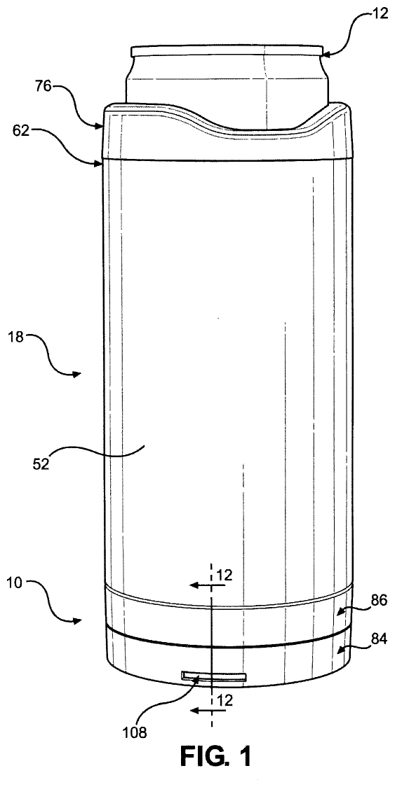

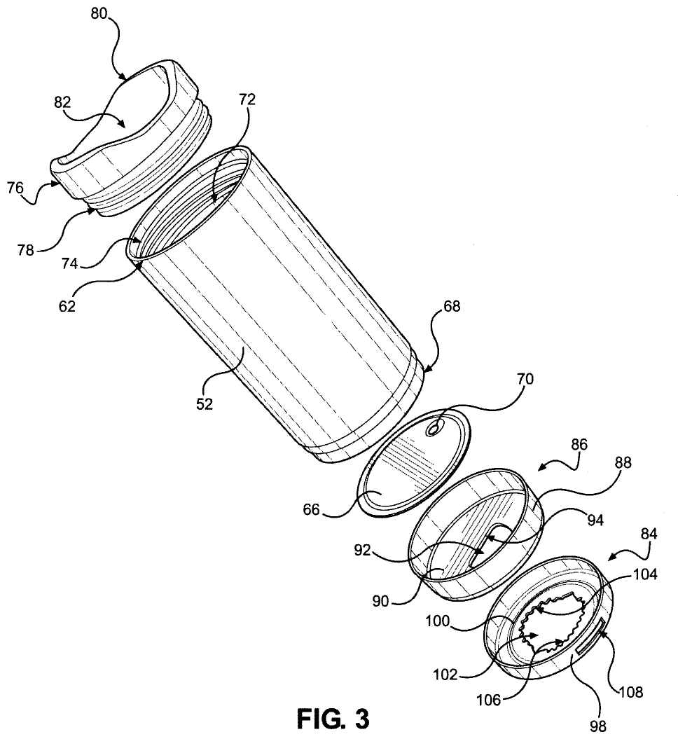

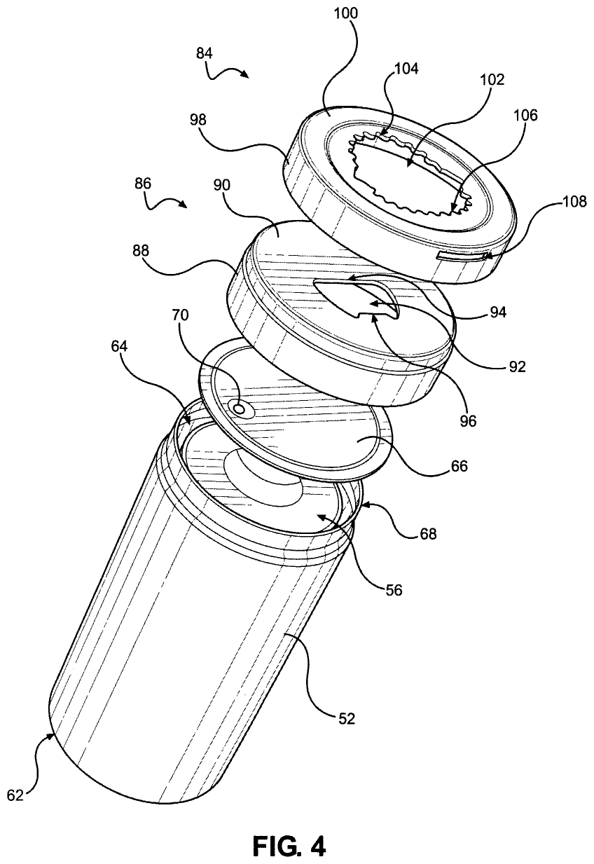

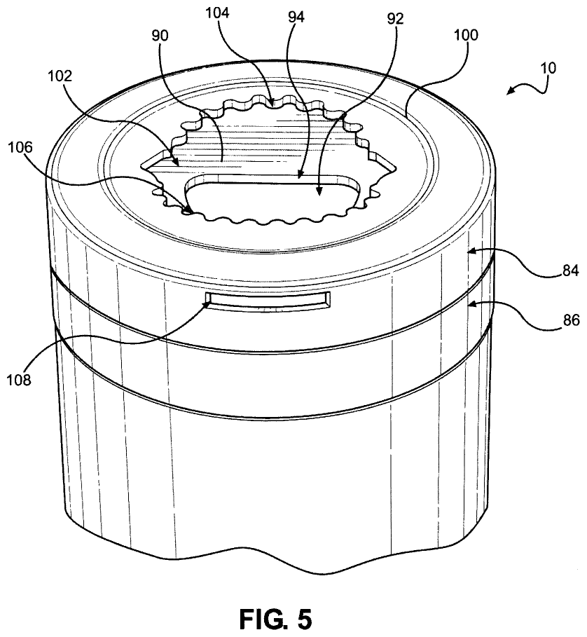

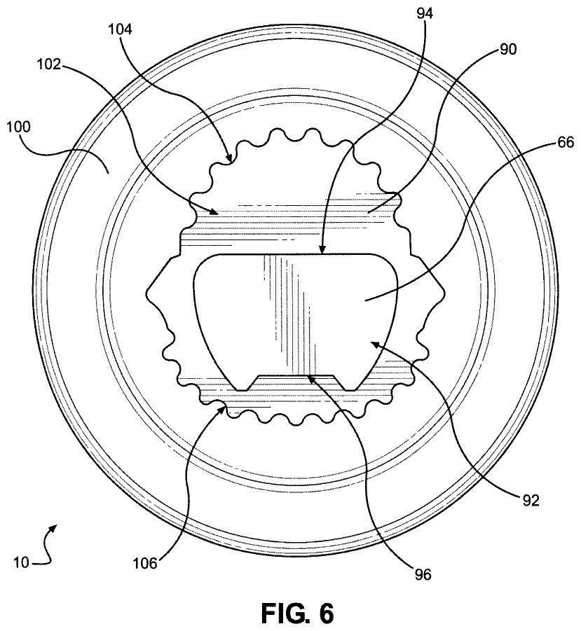

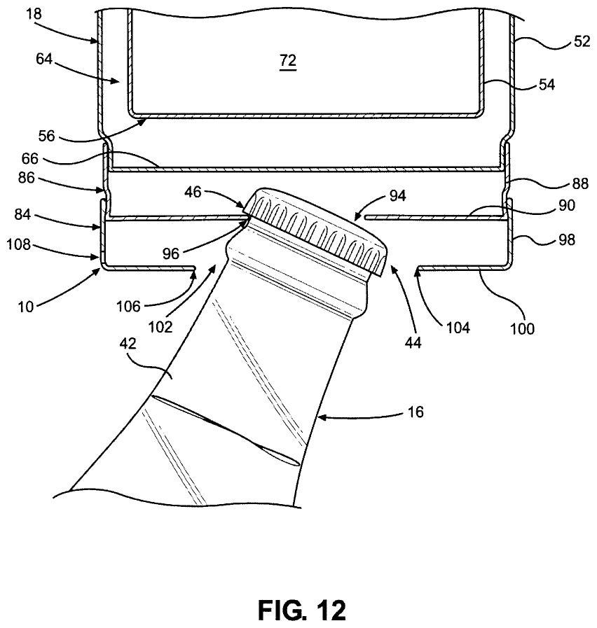

An implement constructed in accordance with principles of the present invention for opening sealed beverage lever tab cans 12, twist cap bottles 14 and pop-off cap bottles 16 is shown and generally designated by the numeral 10 in the FIGS. 1 through 14. Implement 10 can be integrated and combined with beverage container insulating sleeves 18 commonly known as “coolers”.

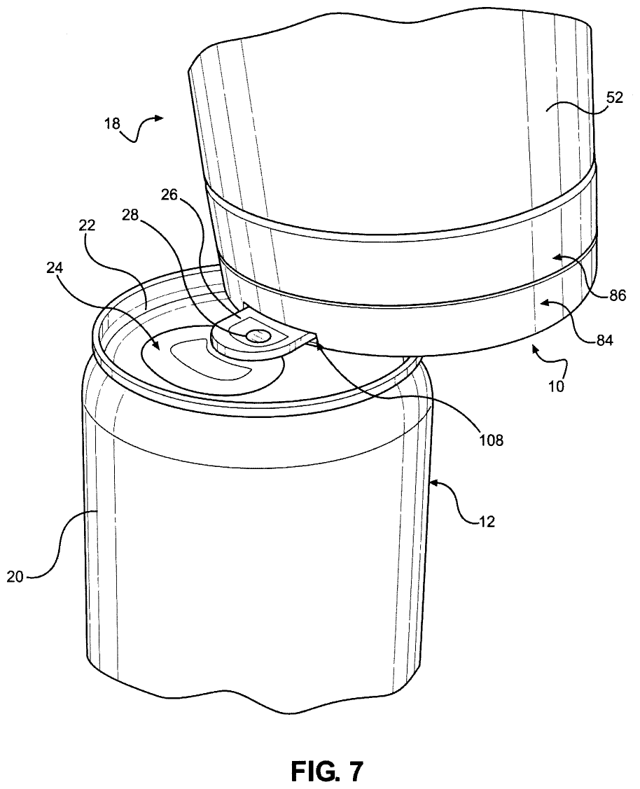

As best seen in FIG. 7, sealed beverage lever tab cans 12 typically comprise an aluminum or steel housing enclosure 20 with a top lid 22. Top lid 22 includes a pre-scored flap 24 and a lever tab 26 riveted to the top lid 22 adjacent the pre-scored flap 24 with a rivet 28. Lever tab cans 12 are sealed and are openable, in a known and customary manner, by tipping up the lever tab 26 so as to pivot about rivet 28 and pushing/punching the pre-scored flap 24 into the housing enclosure 20, for thereby creating a drink opening through the top lid 22.

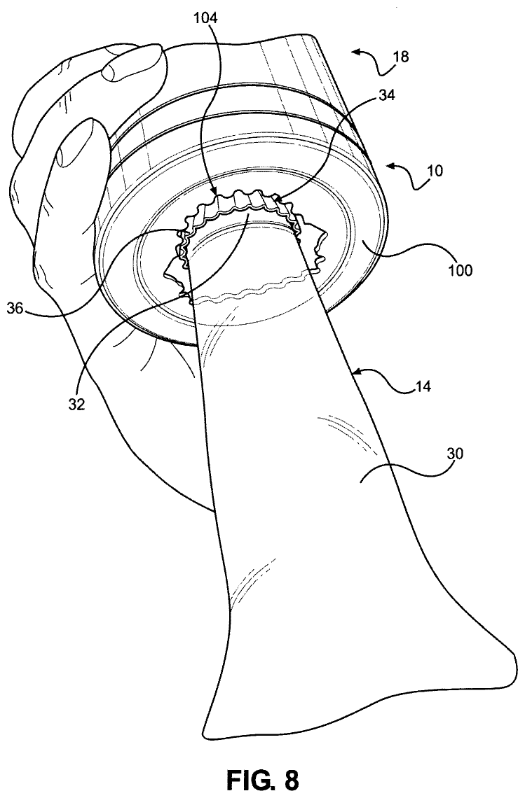

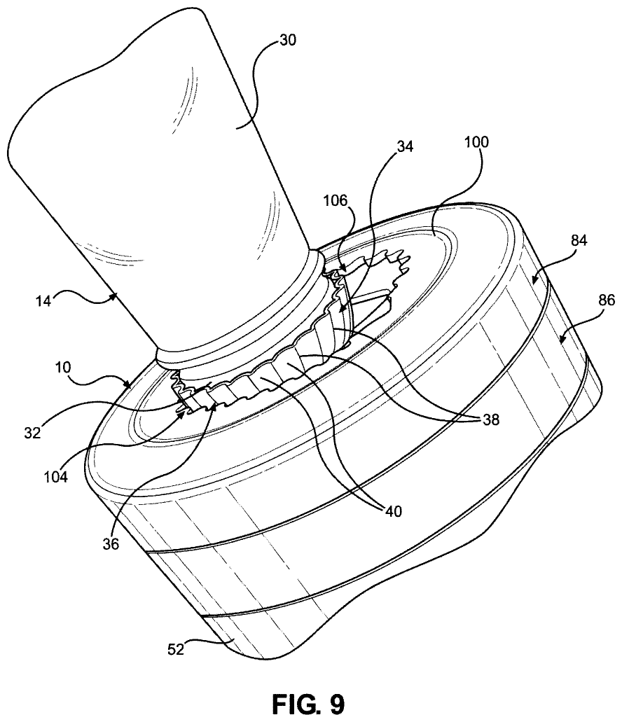

As best seen in FIGS. 8 and 9, sealed beverage twist cap bottles 14 typically comprise a glass housing enclosure 30 with integrally formed threads 32 at the opening thereof. A twist off crown cap 34, typically made of steel or other metal, is secured at and around the bottle opening with the bent pleated cap edge 36 thereof extending over the threads 32. The pleated cap edge 36 includes alternating raised peaks 38 and valleys 40 thereby forming a generally sinusoidal shape therearound. Twist cap bottles 14 are openable, in a known and customary manner, by twisting the crown cap 34 counterclockwise relative to the glass housing enclosure 30 for threadingly disengaging the cap 34 from the glass housing enclosure 30, and for thereby allowing access to the bottle opening.

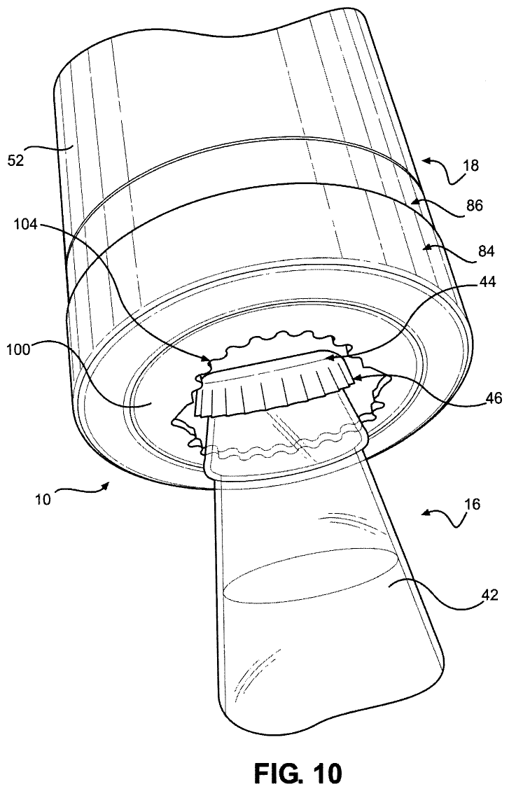

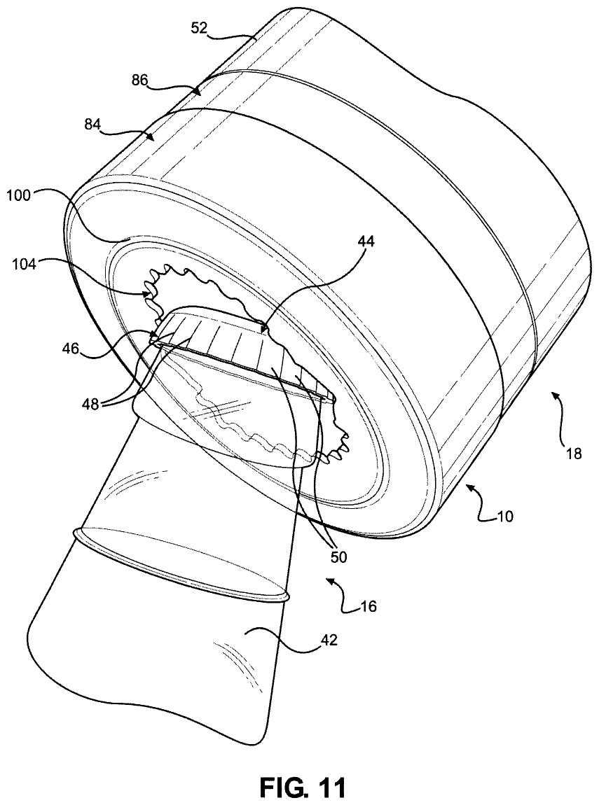

As best seen in FIGS. 10 and 11, sealed beverage pop-off cap bottles 16 comprise a glass housing enclosure 42 with an annular lip extending radially outwardly around the bottle opening (not shown) in a known and customary manner. A pop-off crown cap 44, typically made of steel or other metal, is secured at and around the bottle opening with the bent pleated cap edge 46 thereof extending over the annular lip. The pleated cap edge 46 similarly includes alternating raised peaks 48 and valleys 50 thereby forming a generally sinusoidal shape therearound. The pop-off cap bottles 16 are openable, in a known and customary manner, with a lever opener comprising a hole at one end of a handle, wherein the hole is adapted to be placed over and partially receive therein the pop-off crown cap 44. The lever opener hole is defined by opposing fulcrum and lift edges whereby, when the pop-off crown cap 44 is partially received in the hole, the fulcrum edge is placed atop and generally in the middle of the cap and the lift edge is placed under the pleated cap edge 46. Accordingly, by lifting and rotating the lever opener handle about the fulcrum edge, the pleated cap edge 46 is pushed upwardly over the bottle annular lip thereby bending and removing/disengaging the pop-off crown cap 44 from the glass housing enclosure 42, and for thereby allowing access to the bottle opening.

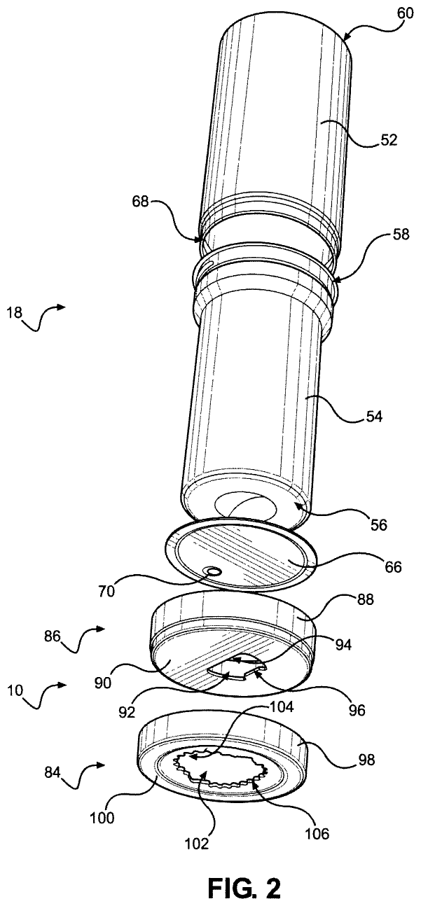

Referring now primarily to FIG. 2, insulating sleeve 18 can be constructed with an outer cylinder 52 made of a thin sheet of steel or other metal which is received over and around an inner cylindrical cup 54 also made of a thin sheet of steel or other metal. The cup 54 includes a bottom closed end 56. The top annular edge 58 of the cup 54 is sealingly welded to the top annular edge 60 of the outer cylinder 52. The cup 54 and outer cylinder 52 thereby define the sleeve annular edge opening 62 and a cylindrical cavity 64 therebetween. A disk 66, also made of a thin sheet of steel or other metal, is sealingly welded to the bottom annular edge 68 of the outer cylinder 52 thereby hermetically sealing the cylindrical cavity 64 from the atmosphere. A valve and/or an opening and plug 70 is provided through the disk 66 whereby air from within the cylindrical cavity 64 is withdrawn and a vacuum is created and maintained therein for thereby thermally insulating between the cup beverage container sleeve cavity 72 and the outside surface of the outer cylinder 52.

The inner cup 54 adjacent the sleeve annular edge opening 62 can be formed or otherwise provided with sleeve cavity threads 74. A plastic cooler cap 76 can be provided which is adapted to be partially received in the sleeve cavity 72 and includes cap threads 78 for threadingly engaging with the sleeve cavity threads 74. Cooler cap 76 preferably includes an undulating shaped top annular edge 80. The plastic cooler cap 76 can, essentially, be cylindrical shaped with an through hole 82 extending therethrough and communicating with the cup container sleeve cavity 72 whereby a beverage, e.g. coffee, water, tea, beer etc., can be poured therethrough directly into the container sleeve cavity 72 whereat it is thermally insulated and can be consumed by tipping the sleeve 18 and placing one's mouth/lips on the undulating top annular edge 80. Alternatively, a beverage container 12, 14 and 16 can be received through the cap through hole 82 and within the cup container sleeve cavity 72, for example as shown in FIG. 1, whereby the beverage within the container is thermally insulated and can be consumed by tipping the sleeve 18 and placing one's mouth/lips on the opening of the beverage container 12, 14 and 16. It is contemplated that the cooler cap 76 can be sealed so as to prevent inadvertent spillage of the beverage therein and can be provided with a selectively openable flow through window for consuming the beverage. Additionally, it is contemplated that a cap 76 can be dispensed with altogether so that the sleeve annular edge opening 62 fundtions as the edge whereat one's mounth/lips can be placed for consuming a beverage within the cup container sleeve cavity 72. Also, in such an embodiment, a beverage container 12, 14, 16 can be received directly into the cup container sleeve cavity 72 through the sleeve opening 62.

It is further contemplated that the insulating sleeve 18 can, instead of being constructed to have a thermally insulating vacuum barrier, be made of solid thermally insulative materials such as low-density plastic, foam, etc. by, for example, injection molding.

An implement 10 can be integrated with the insulating sleeve 18 and can be constructed with an outer/terminal twist cap tool member 84 and an inner/central pop-off tool member 86 sandwiched between the twist cap tool member 84 and the insulating sleeve 18. Both twist cap tool member 84 and pop-off tool member 86 are also made of a thin sheet of steel or other metal.

The pop-off tool member 86 is cup shaped having a cylindrical portion 88 and a generally flat/planar section 90. A pop-off crown cap tool opening 92 is provided through the planar section 90 and is defined by a fulcrum edge 94 and an opposing lift edge 96. The fulcrum edge 94 is spaced from the lift edge 96 sufficiently so that the size of the pop-off crown opening 92 is such that the pop-off tool member 86 can be placed over and to partially receive a pop-off crown cap 44 with the fulcrum edge 94 atop and generally in the middle of the cap 44 and with the lift edge 96 under the pleated edge 46, in a known and customary manner, as shown in FIGS. 10 and 11. The diameter of the cylindrical portion 88 is slightly larger than the outer cylinder 52 bottom annular edge 68 whereby the cylindrical portion 88 can be slipped over the annular edge 68 and welded thereto.

The twist off cap tool member 84 is cup shaped having a cylindrical portion 98 and a generally flat/planar section 100. A twist off crown cap receiving opening 102 is provided through the planar section 100 and includes a sinusoidal shaped edge 104 extending along an arc length of slightly less than 180° and sized and shaped to engage the sinusoidal shape of a twist off crown cap 34 pleated edge 36 as described herein above. An opposing edge 106 of the twist off crown cap receiving opening 102 is sufficiently distant from the sinusoidal shaped edge 104 so as to increase the size of the opening 102 to allow a pop-off crown cap 44 and bottle top end thereof to be inserted therethrough and to be partially received in the pop-off crown tool opening 92 as described hereinabove. The diameter of the twist off cap tool member 84 cylindrical portion 98 is slightly larger than the diameter of the pop-off tool member 86 cylindrical portion 88 adjacent the planar portion 90 thereof, whereby the twist off cap tool member cylindrical portion 98 can be slipped over the pop-off tool member cylindrical portion 88 and welded thereto.

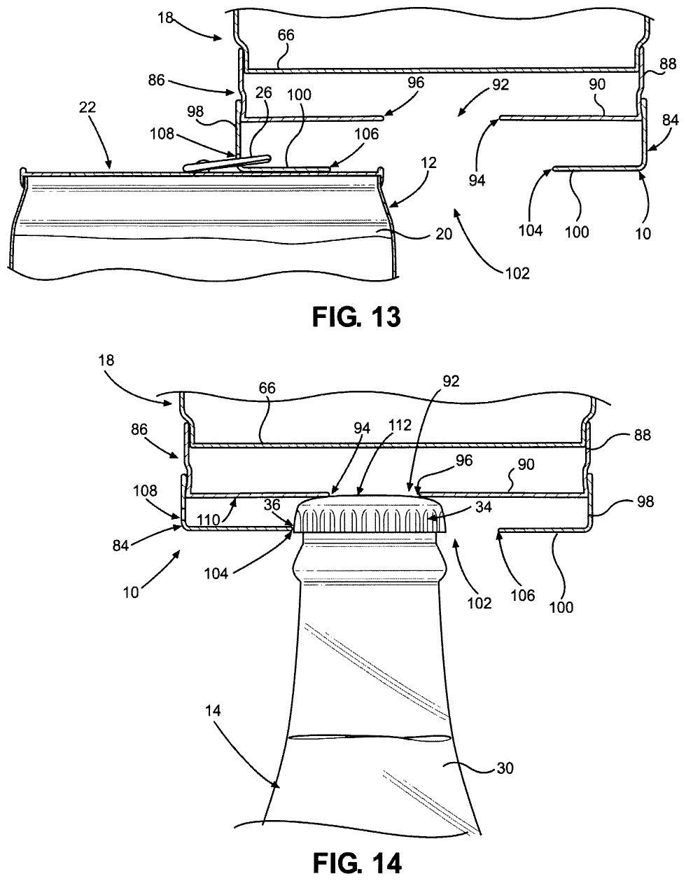

A lever tab receiving rectangular shaped slot 108 is provided through the twist off cap tool member cylindrical portion 98 close to and adjacent the planar section 100 thereof. Slot 108 is sized to receive therethrough a lever tab 26 of a lever tab can 12 as shown in FIGS. 7 and 13. Slot 108 is sufficiently close to and adjacent the planar section 100 so that the planar section 100 can readily be slipped between the lever tab 26 and the can top lid 22 while the lever tab 26 is being inserted/received through the slot 108. During and/or after the lever tab 26 is received through the slot 108, the insulating sleeve 18 and implement 10 secured thereto are tipped as shown in FIGS. 7 and 13 relative to the can 12 causing the planar section 100 to engage and tip up the lever tab 26 thereby pivoting the lever tab 26 about its rivet 28 and pushing/punching the pre-scored flap 24 into the housing enclosure 20 and thereby creating a drink opening through the top lid 22.

For opening a twist off cap bottle 14, as seen in FIGS. 8, 9 and 14, the twist off crown cap 34 thereof is inserted into the twist off crown cap receiving opening 102 and the sinusoidal shaped pleated edge 36 thereof is placed against and in engagement with the corresponding sinusoidal shaped edge 104, and the insulating sleeve 18 and implement 10 secured thereto are twisted counterclockwise relative to the bottle 14 for threadingly disengaging the cap 34 from the glass housing enclosure 30, and for thereby allowing access to the bottle 13 opening.

For opening a pop-off cap bottle 16, as seen in FIGS. 10, 11 and 12, the pop-off crown cap 44 and top portion of the bottle enclosure 42 thereof are inserted through the twist off crown cap receiving opening 102 until the pop-off crown cap 44 is partially received in the pop off crown cap tool opening 102, placing the fulcrum edge 94 atop and generally in the middle of the cap 44 and the lift edge 96 under the pleated edge 46. The insulating sleeve 18 and implement 10 secured thereto are then rotated about the fulcrum edge 94 causing the lift edge 96 to push the pleated cap edge 46 upwardly and over the bottle annular lip, thereby bending and removing/disengaging the pop-off crown cap 44 from the glass housing enclosure 42, and for thereby allowing access to the bottle 16 opening.

While this invention has been described as having an exemplary design, the present invention may be further modified within the spirit and scope of this disclosure. This application is therefore intended to cover any variations, uses, or adaptations of the invention using its general principles.

What is claimed is:

1. An implement for opening a sealed beverage container, the implement comprising:
a pop-off cap opening tool, wherein the pop-off cap opening tool is engageable with a pop-off cap;
a twist off cap opening tool, wherein the twist off cap opening tool is engageable with a twist off cap;
wherein the pop-off cap opening tool is secured to the twist off cap opening tool;
a passage opening extending through the twist off cap opening tool wherethrough the pop-off cap opening tool is accessible; and,
wherein, for engaging the pop-off cap with the pop-off cap opening tool, the pop-off cap is inserted through the passage opening.

2. The implement of claim 1, further comprising a lever tab opening tool, wherein the lever tab opening tool is engageable with a lever tab.

3. The implement of claim 2, wherein the lever tab opening tool is a lever tab receiving slot extending into a side of the implement.

4. The implement of claim 1, wherein the pop-off cap opening tool comprises:
a pop-off tool member having a first base section; and,
a pop-off cap receiving opening provided through the first base section;
wherein the pop-off cap receiving opening has a fulcrum edge and a lift edge opposite the fulcrum edge; and,
wherein the fulcrum edge and the lift edge are configured to engage the pop-off cap.

5. The implement of claim 1, wherein the twist off cap opening tool comprises:
a twist off tool member having a second base section; and,
a twist off cap receiving opening provided through the second base section;
wherein the twist off cap receiving opening has a plurality of sinusoidal ridges extending along a first edge thereof; and,
wherein the plurality of sinusoidal ridges are configured to engage the twist off cap.

6. The implement of claim 5, wherein the first edge extends along an arc length less than 180°.

7. The implement of claim 5, wherein the twist off cap receiving opening is sized to allow a pop-off cap to pass therethrough and thereby engage the pop-off cap opening tool, whereby the twist off cap receiving opening functions as the passage opening.

8. The implement of claim 1, wherein the pop-off cap opening tool comprises:
a pop-off tool member having a first base section; and,
a pop-off cap receiving opening provided through the first base section;
wherein the pop-off cap receiving opening has a fulcrum edge and a lift edge opposite the fulcrum edge;
wherein the fulcrum edge and the lift edge are configured to engage the pop-off cap; and,
wherein the twist off cap opening tool comprises:
a twist off tool member having a second base section; and,
a twist off cap receiving opening provided through the second base section;
wherein the twist off cap receiving opening has a plurality of sinusoidal ridges extending along a first edge thereof; and,
wherein the plurality of sinusoidal ridges are configured to engage the twist off cap.

9. The implement of claim 8, wherein the twist off cap receiving opening is sized such that the twist off cap receiving opening functions as the passage opening allowing the pop-off cap to be inserted through the twist off cap receiving opening and engage the pop-off cap receiving opening.

10. The implement of claim 8, wherein the first base section further comprises a bottom surface which is adjacent and facing the second base section;
wherein the twist off cap further comprises a top surface; and,
wherein, when the twist off cap engages the twist off cap receiving opening, the top surface of the twist off cap abuts the bottom surface of the first base section.

11. An implement for opening a sealed beverage container, the implement comprising:
a beverage container;
a pop-off cap opening tool, wherein the pop-off cap opening tool is engageable with a pop-off cap; and,
a twist off cap opening tool, wherein the twist off cap opening tool is engageable with a twist off cap;
wherein the pop-off cap opening tool is located between the beverage container and the twist off cap opening tool;
a passage opening extending through the twist off cap opening tool wherethrough the pop-off cap opening tool is accessible; and,
wherein, for engaging the pop-off cap with the pop-off cap opening tool, the pop-off cap is inserted through the passage opening.

12. The implement of claim 11, further comprising a lever tab opening tool, wherein the lever tab opening tool comprises a lever tab receiving slot extending into the implement and is engageable with a lever tab.

13. The implement of claim 11, wherein the pop-off cap opening tool comprises:
a pop-off tool member having a first base section; and,
a pop-off cap receiving opening provided through the first base section;
wherein the pop-off cap receiving opening has a fulcrum edge and a lift edge opposite the fulcrum edge; and,
wherein the fulcrum edge and the lift edge are configured to engage the pop-off cap.

14. The implement of claim 11, wherein the twist off cap opening tool comprises:
a twist off tool member having a second base section; and,
a twist off cap receiving opening provided through the second base section;
wherein the twist off cap receiving opening has a plurality of sinusoidal ridges extending along a first edge thereof; and,
wherein the plurality of sinusoidal ridges are configured to engage the twist off cap.

15. The implement of claim 13, wherein the twist off cap opening tool comprises:
a twist off tool member having a second base section; and,
a twist off cap receiving opening provided through the second base section;
wherein the twist off cap receiving opening has a plurality of sinusoidal ridges extending along a first edge thereof; and,
wherein the plurality of sinusoidal ridges are configured to engage the twist off cap.

16. The implement of claim 15, wherein the twist off cap receiving opening is sized such that the twist off cap receiving opening functions as the passage opening allowing the pop-off cap to be inserted through the twist off cap receiving opening and engage the pop-off cap receiving opening.

17. The implement of claim 16, wherein the first base section further comprises a bottom surface which is adjacent and facing the second base section;
wherein the twist off cap further comprises a top surface; and,
wherein, when the twist off cap engages the twist off cap receiving opening, the top surface of the twist off cap abuts the bottom surface of the first base section.

18. The implement of claim 11, wherein the beverage container is thermally insulated.

19. The implement of claim 18, wherein the thermally insulated container comprises:
an outer cylindrical member;
an inner cup member received within the outer cylindrical member; and,
wherein the outer cylindrical member and the inner cup member form an insulative cylindrical air vacuum cavity therebetween.

20. The implement of claim 18, wherein the thermally insulated container is constructed from a low density thermally insulative material.
